(19) United States
(12) Patent Application Publication
(10) Pub. No.: US 2013/0272434 A1
(43) Pub. Date: Oct. 17, 2013

(54) ELECTRONIC DEVICE WITH VIDEO PLAYBACK FUNCTION

(71) Applicant: TAO WANG, Shenzhen City (CN)

(72) Inventor: TAO WANG, Shenzhen City (CN)

(21) Appl. No.: 13/655,586

(22) Filed: Oct. 19, 2012

(30) Foreign Application Priority Data
Apr. 13, 2012 (CN) 201210107524.1

(51) Int. Cl. H04N 7/26

(52) U.S. Cl. 375/240.29; 375/E07.193

(57) ABSTRACT

An electronic device includes a video port, a codec chip, a Pi type filter, a coupling capacitor, and a path switch. The codec chip outputs video signals. The Pi type filter filters noise from the video signals. The coupling capacitor and the path switch are connected in parallel between the Pi type filter and the video port. When the electronic device is connected to another electronic device, the codec chip turns off the path switch, and the coupling capacitor filters direct current from the video signals from which any noise has been filtered and transmits the video signals to the another electronic device. When the electronic device is connected to a display device, the codec chip turns on the path switch, the video signals from which only noise has been filtered are directly transmitted to the display device via the path switch.

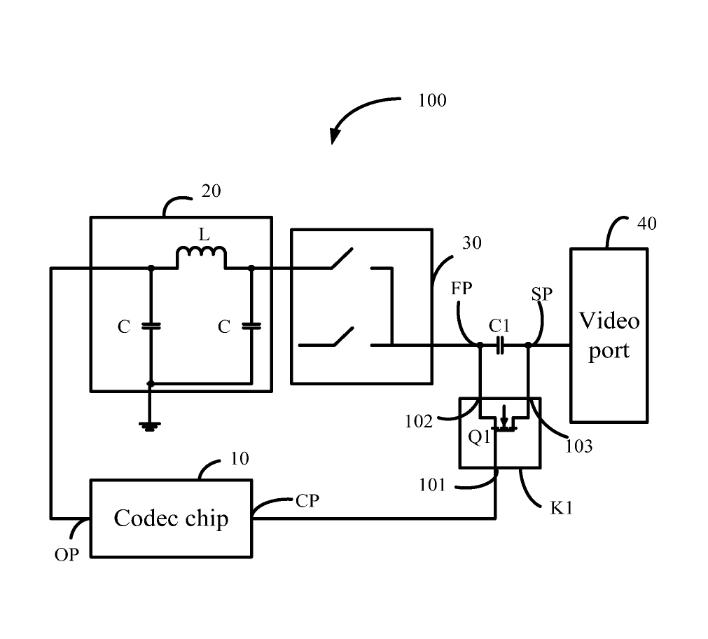

### BACKGROUND

1. Technical Field

The present disclosure relates to electronic devices and, particularly, to an electronic device with a video playback function.

2. Description of Related Art

Electronic devices with a video playback function, such as mobile phones, tablets, computers, digital photo frames, and digital cameras, are popular. The electronic device can output video signals to a display device to display images corresponding to the video signals. The electronic device also can transmit video signals to another electronic device. For example, a mobile phone may transmit a video signal to a tablet computer or another mobile phone. For different electronic devices, the video signals may be provided with a different direct current voltage, therefore the different-level direct current must be filtered from the video signals when the electronic device transmits the video signals to another electronic device. The usual method to filter the direct current from the video signals is to connect a capacitor to a video port of the electronic device, wherein the video signals are firstly filtered by the capacitor, and then transmitted to another electronic device via the video port. However, when the video signals need to be transmitted to the display device, the video signals themselves are also filtered by the capacitor, which causes display distortion and other problems.

An electronic device with a video playback function to overcome the described limitations is thus needed.

### BRIEF DESCRIPTION OF THE DRAWINGS

Many aspects of the present disclosure are better understood with reference to the drawing. The components in the drawing are not necessarily drawn to scale, the emphasis instead being placed upon clearly illustrating the principles of the present disclosure.

The FIGURE is a circuit diagram of an embodiment of an electronic device with a video playback function.

### DETAILED DESCRIPTION

Embodiments of the present disclosure will be described with reference to the accompanying drawing.

The FIGURE illustrates, in the embodiment, an electronic device 100 with a video playback function. The electronic device 100 includes a codec chip 10, a Pi type filter 20, a video switch 30, a video port 40, a coupling capacitor C1, and a path switch K1.

The codec chip 10 includes a signal output port OP and a control port CP. The codec chip 10 outputs video signals via the signal output port OP.

The Pi type filter 20 is connected to the signal output port OP of the codec chip 10, and is used to filter noise from the video signals. In one embodiment, the Pi type filter 20 includes two capacitor C and a inductor L.

The video switch 30 is connected between the Pi type filter 20 and a first port FP of the coupling capacitor C1, and connects the Pi type filter 20 with the first port FP of the coupling capacitor C1, or breaks the connection between the Pi type filter 20 and the first port FP of the coupling capacitor C1.

A second port SP of the coupling capacitor C1 is connected to the video port 40. The coupling capacitor C1 filters the direct electrical current of the video signals from which the noise has been filtered.

The path switch K1 is also connected between the video switch 30 and the video port with the coupling capacitor C1. The path switch K1 includes a control terminal 101, a first path terminal 102, and a second path terminal 103. The control terminal 101 is connected to the control port CP of the codec chip 10. The first path terminal 102 is connected to the first port FP of the capacitor C1 and the second path terminal 103 is connected to the second port SP of the capacitor C1.

When the electronic device 100 is connected to another electronic device (not shown), the codec chip 10 outputs a first control signal to the control terminal 101 of the path switch K1 to turn off the path switch K1. Therefore, the coupling capacitor C1 filters the direct current from the video signals from which the noise has been filtered and transmits the video signals from which the direct current and the noise have been filtered to the another electronic device via the video port 40.

When the electronic device 100 is connected to a display device, such as a liquid crystal display, the codec chip 10 outputs a second control signal to the control terminal 101 of the path switch K1 to turn on the path switch K1. Then the video signals from which the noise has been filtered are transmitted to the video port 40 via the path switch K1 which is turned on directly. Therefore, the video signals, after being filtered for noise content, are transmitted to the display device without being filtered further by the coupling capacitor C1, thereby ensuring that the display content is clear when the display device displays the content according to the video signals.

In one embodiment, the display device is used only as a display, and only used to display content, such as the liquid crystal display or electronic paper, for example. The other electronic device to which the electronic device 100 may be connected may be able to execute a number of functions, such as play video or make a telephone call, for example.

In one embodiment, when the electronic device 100 is connected to another electronic device or to a display device, a user can invoke functions through a menu or buttons to produce operation signals, the codec chip 10 receives the operation signals and determines whether the electronic device 100 is connected to another electronic device or to a display device according to the operation signals. The codec chip 10 outputs the first control signal when determining that the electronic device 100 is connected to another electronic device, and outputs the second control signal when determining that the electronic device 100 is connected to the display device.

In another embodiment, when the electronic device 100 is connected to another electronic device or to a display device, a voltage of the video port is different. The codec chip 10 is connected to the video port 40 and can detect the voltage of the video port 40 and thus detect a different voltage to determine whether the electronic device 100 is connected to another electronic device or to a display device.

In one embodiment, the path switch K1 is a digital-high activated switch, and can be an N-channel metal-oxide-semiconductor field-effect transistor (NMOSFET) Q1 as shown in the FIGURE. A gate, a source, and a drain of the NMOSFET Q1 correspond to the control terminal 101, the first path terminal 102, and the second path terminal 103 of the path switch K1. The first control signal is a digital-low signal and the second control signal is a digital-high signal. In another embodiment, the NMOSFET Q1 can be replaced by a negative-positive-negative bipolar junction transistor (npn BJT).

In another embodiment, the first control signal is the digital-high signal, and the second control signal is the digital-low signal. The path switch is a digital-low activated switch, such as a P-channel metal-oxide-semiconductor field-effect transistor or a positive-negative-positive bipolar junction transistor.

In one embodiment, the Pi type filter includes two capacitors (not labeled) and an inductor (not labeled).

In one embodiment, the electronic device 1 can be a mobile phone, a digital camera, a digital photo frame, or a tablet computer, for example.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being embodiments of the present disclosure.

What is claimed is:

1. An electronic device comprising:
a video port;
a codec chip comprising a signal output port and a control port, and configured to output video signals via the signal output port;
a Pi type filter connected to the signal output port, and configured to receive the video signals from the codec chip and filter noise from the video signals;
a coupling capacitor comprising a first port and a second port, the second port being connected to the video port;
a video switch connected between the Pi type filter and the first port of the coupling filter, and configured to select the Pi type filter to connect to the first port FP of the coupling capacitor; and
a path switch comprising a control terminal, a first path terminal, and a second path terminal, wherein the control terminal is connected to the control port of the codec chip, the first path terminal is connected to the first port of the coupling capacitor, and the second path terminal is connected to the second port of the coupling capacitor; when the electronic device is connected to another electronic device via the video port, the codec chip outputs a first control signal to the control terminal of the path switch via the control port to turn off the path switch, thereby the coupling capacitor filters direct current from the video signals from which noise has been filtered signals and transmits the video signals from which the direct current and the noise have been filtered to the another electronic device via the video port; when the electronic device is connected to a display device via the video port, the codec chip outputs a second control signal to the control terminal of the path switch via the control port to turn on the path switch, thereby the video signals from which the noise has been filtered are transmitted to the display device via the path switch which is turned on directly.

2. The electronic device according to claim 1, wherein the path switch is a digital-high activated switch, the first control signal is a digital-low signal and the second control signal is a digital-high signal.

3. The electronic device according to claim 2, wherein the patch switch is an N-channel metal-oxide-semiconductor field-effect transistor or a negative-positive-negative bipolar junction transistor.

4. The electronic device according to claim 1, wherein the first control signal is the digital-low signal, the second control signal is the digital-high signal, and the path switch is a digital-low activated switch.

5. The electronic device according to claim 4, wherein the path switch is a P-channel metal-oxide-semiconductor field-effect transistor or a positive-negative-positive bipolar junction transistor.

6. The electronic device according to claim 1, wherein the codec chip receives operation signals produced by operating menu or buttons by a user, and determines whether the electronic device is connected to another electronic device or the display device according to the operation signals.

7. The electronic device according to claim 1, wherein the codec chip detects a voltage of the video port to determine whether the electronic device is connected to another electronic device or the display device via the video port.

8. The electronic device according to claim 1, wherein the electronic device is one selected from a group consist of a mobile phone, a digital camera, a digital photo frame, and a tablet computer.

9. The electronic device according to claim 1, wherein the Pi type filter comprises two capacitors and a inductor.
